(19) United States
(12) Patent Application Publication
(10) Pub. No.: US 2023/0138233 A1
(43) Pub. Date: May 4, 2023

(54) Fastener Assembly and Method of Use

(71) Applicant: Anthony DeCarmine, Lebanon, CT (US)

(72) Inventor: Anthony DeCarmine, Lebanon, CT (US)

(21) Appl. No.: 17/497,817

(22) Filed: Oct. 29, 2021

(51) Int. Cl. F16B 5/02; F16B 37/04

(52) U.S. Cl. CPC F16B 5/0266; F16B 37/048

(57) ABSTRACT

An assembly for securing a workpiece. The workpiece includes a bore having a first opening in a first surface of the workpiece. A limiter extends between a proximal end and distal end and defines a bore and is received in at least a portion of the bore of the workpiece. A fastener extends along an axis between a proximal end and a distal end. The fastener has a head at the proximal end and a plurality of threads at the distal end. The fastener is received in the bore of the workpiece so that the distal end of the fastener having the plurality of threads is opposite the first opening of the bore. A first spring element is disposed about the fastener and is between the head of the fastener and the first surface of the workpiece. The first spring element is configured to generate a deflection force when the first spring element is subjected to a compression force during a tensioning of the assembly.

### TECHNICAL FIELD

The present disclosure generally relates to a fastener assembly. More specifically, the present invention relates to a fastener assembly that inhibits damage to composite workpieces.

### BACKGROUND

Fastener assemblies are used to fix the position of one or more members of a workpiece. For example, a fastener assembly may fix a first member of a workpiece to a second member of the workpiece. Alternatively, the fastener may fix the workpiece to a larger structure such as the frame of a vehicle.

A typical fastener comprises a bolt having a head, shaft and threaded distal end. A nut is received on threads on the end. The workpiece, comprising one or more elements, is secured by a compression force between the bolt head and the nut.

Common bolted joints rely on both of the compressive strength and resilience of the articles joined; and; the tensile strength and resilience of the fastening assembly. When these factors are well aligned, as in the case of steel plates bolted with steel threaded bolts with nuts, it is readily possible to balance the elastic elongation of the fastener against the elastic compression of the plates to achieve a stable joint, resilient to applied loads, thermal expansion and other typical forces that define the life of a bolted joint.

Bolted joints fail through an array of mechanisms. Three of these are coefficient of thermal expansion (CTE) mismatch between fastener and workpiece, dimensional deviations of workpiece, and crushing of workpiece from overtightening. These events may occur separately or in combination.

The situation changes markedly when attempts are made to use a high stiffness fastener to join lower stiffness and/or strength plates, as is the case when bolting plastic or composite items together. Experience shows that a steel bolt and nut can be too easily tightened past the tolerance of the plastic plates, resulting in cracking or fracture of the plates.

Combinations of workpiece and fastener materials having different CTE values can fail by loosening (when the workpiece is made relatively smaller by temperature change) or overtightening (when the workpiece becomes relatively larger by temperature change) and thus cause failure. It is often proposed to use similar materials for fasteners, which often fails the usefulness test in that such devices vastly fail creep and fatigue requirements.

Mismatches in dimensional tolerance of workpieces may also undermine bolted joints by defeating planned fits and tolerance stackup. Commonly, these issues are worked either with highly specified tolerances (expensive) or the use of shims (requires substantial $$ touch time to fit).

There is prior art proposing to remedy this problem with completely new designs of fasteners involving combinations of new geometries and plastically deformable elements. These concepts fail to address the requirement for established reliable performance and specific technical details (commonly available for in-use threaded fasteners) that preclude solving the fastening problem, creating new problems.

Thus, there exists a need in the art for an improved fastening assembly and apparatus for securing a workpiece having one or more members.

### SUMMARY OF THE INVENTION

The needs set forth herein as well as further and other needs and advantages are addressed by the present teachings, which illustrate solutions and advantages described below.

The present invention resides in one aspect in an assembly for securing a workpiece. The assembly includes a workpiece defining a bore having a first opening in a first surface of the workpiece. The assembly includes a limiter extending between a proximal end and distal end. The limiter defines a bore between an opening at the proximal end and an opening at the distal end. The limiter is received in at least a portion of the bore of the workpiece. The assembly further includes a fastener extending along an axis between a proximal end and a distal end. The fastener has a head at the proximal end. The fastener has a plurality of threads at the distal end. The fastener is received in the bore of the workpiece so that the distal end of the fastener having the plurality of threads is opposite the first opening of the bore. The fastener is received in the bore of the limiter. The assembly further includes a first spring element disposed about the fastener and being between the head of the fastener and the first surface of the workpiece. The first spring element is configured to generate a deflection force when the first spring element is subjected to a compression force during a tensioning of the assembly.

In yet a further embodiment of the present invention the assembly comprises a first washer disposed about the fastener between the head of the fastener and the first spring element. The first washer is configured to transfer force between the first spring element and the head of the fastener when the assembly is tensioned.

In yet a further embodiment of the present invention, the assembly includes a second washer disposed about the fastener between the first spring element and the first surface of the workpiece. The first washer is configured to transfer force between the first spring element and the first surface of the workpiece when the assembly is tensioned.

In yet a further embodiment of the present invention, the assembly includes a nut received about the threaded portion of the fastener. The nut has a threaded portion configured to engage with the threaded portion of the fastener. The engagement between the fastener and the nut is configured whereas rotation of the fastener relative to the nut in a first direction tensions the assembly.

In yet a further embodiment of the present invention, a length of the first spring element is less than an equilibrium length of the first spring element when the assembly is tensioned.

In yet a further embodiment of the present invention, the proximal end of the limiter is one or more of flush with the first surface of the workpiece or protruding from the first surface of the workpiece.

In yet a further embodiment of the present invention, the proximal end of the limiter protrudes from the first opening in the first surface of the workpiece and is configured to inhibit a compression force generated on the workpiece caused by one or more of over tensioning of the assembly and thermal contraction.

In yet a further embodiment of the present invention, the length of the spring element varies over a working temperature delta greater than 40 degrees Celsius.

In yet a further embodiment of the present invention, the workpiece comprises one or more of a polymer matrix and a ceramic matrix.

In yet a further embodiment of the present invention, the nut comprises a blind nut disposed in bore of the workpiece.

It yet a further embodiment of the present invention, the bore in the workpiece has a second opening in a second surface of the workpiece. The threaded portion of the fastener extends through the second opening in the second surface of the workpiece. The nut is disposed about the threaded portion of the fastener.

In yet a further embodiment of the present invention, the assembly includes a second spring element disposed about the fastener and being between the second surface of the workpiece and the nut. The second spring element is configured to generate an axial force when the second spring element is subjected to a compression force during a tensioning of the assembly.

In yet a further embodiment of the present invention, the assembly includes a third washer disposed about the fastener between the second surface of the workpiece and the second spring element. The third washer is configured to transfer a force between the second surface of the workpiece and the second spring element when the assembly is tensioned. The assembly further includes a fourth washer disposed about the fastener between the second spring element and the nut. The fourth washer is configured to transfer a force between the second spring element and the nut when the assembly is tensioned.

In yet a further embodiment of the present invention, a length of the second spring element is less than an equilibrium length of the second spring element when the assembly is tensioned.

In yet a further embodiment of the present invention, the proximal end of the limiter is one or more of flush with the first surface of the workpiece and protruding from the first surface of the workpiece, and the distal end of the limiter is one or more of flush with the second surface of the workpiece and protruding from the second surface of the workpiece.

In yet a further embodiment of the present invention, the length of the first spring and a length of the second spring varies in response to temperature changes thereby a compression force on the workpiece above a threshold despite dissimilar coefficients of thermal expansion the workpiece and the fastener.

In yet a further embodiment of the present invention, the proximal end of the limiter protrudes from the first bore in the workpiece and the distal end of the limiter protrudes from the second bore and the workpiece.

In yet a further embodiment of the present invention, the length of the limiter is selected so as to define a stop point at which the assembly is properly tensioned when the proximal end of the limiter abuts the head of the fastener and the distal end of the limiter abuts the nut.

The present invention resides in yet another aspect in a method for securing a workpiece with an fastener assembly. The methods includes the step of providing a workpiece defining a bore having a first opening in a first surface of the workpiece. The method further includes the step of providing a limiter extending between a proximal end and distal end. The limiter defines a bore between an opening at the proximal end and an opening at the distal end. The method further includes the step of receiving the limiter in at least a portion of the bore of the workpiece. The method further includes the step of providing a fastener extending along an axis between a proximal end and a distal end. The fastener has a head at the proximal end. The fastener having a plurality of threads at the distal end. The method further includes the step of receiving the fastener in the bore of the workpiece so that the distal end of the fastener having the plurality of threads is opposite the first opening of the bore. The method further includes the step of receiving the fastener in the bore of the limiter. The method further includes the step of providing a first spring element disposed about the fastener and being between the head of the fastener and the first surface of the workpiece. The method further includes the step of-tensioning the fastener so that the first spring element generates a deflection force when the first spring element is subjected to a compression force caused by the tensioning.

### BRIEF DESCRIPTION OF THE DRAWINGS

FIG. 1 illustrates fastener assembly in accordance with one embodiment of the present invention.

FIG. 2 illustrates a fastener assembly in accordance with one embodiment of the present invention.

FIG. 3 illustrates a partial cross-sectional view of the fastener assembly shown in FIG. 1.

FIG. 4 illustrates a partial cross*sectional view of the fastener assembly shown in FIG. 1.

### DETAILED DESCRIPTION

The present teachings are described more fully hereinafter with reference to the accompanying drawings. The following description is presented for illustrative purposes only and the present teachings should not be limited to these embodiments.

In compliance with the statute, the present teachings have been described in language more or less specific as to structural and methodical features. It is to be understood, however, that the present teachings are not limited to the specific features shown and described, since the systems and methods herein disclosed comprise preferred forms of putting the present teachings into effect.

For purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of ‘first’, ‘second,’ etc. for different features/components of the present disclosure are only intended to distinguish the features/components from other similar features/components and not to impart any order or hierarchy to the features/components.

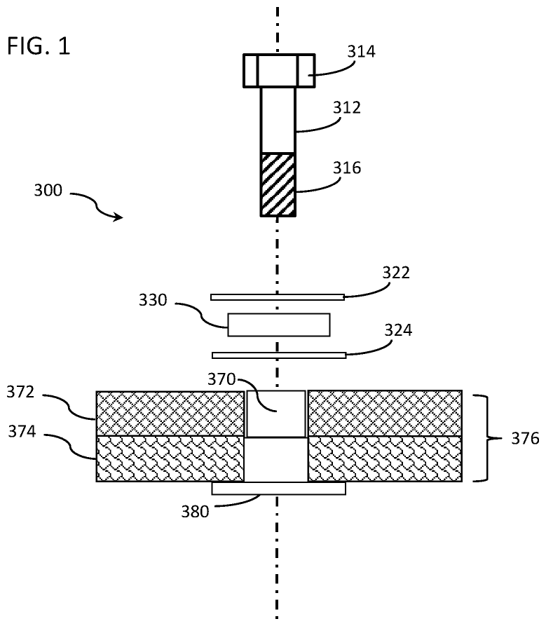

In reference to FIG. 1, an embodiment of the present invention is illustrated. An assembly 300 is provided for securing a workpiece 376. The workpiece may comprise on or more members 372 and 374. The workpiece in the FIGS. is shown as two separate pieces, however, the present invention is not limited in that regard. The disclosed assembly, may, for example, be used to connect two or more pieces of material. The assembly may be used to fasten a part to a frame of a vehicle of the like.

The workpiece may comprise any material, including a metal, a polymer matrix, or a ceramic matrix. In some embodiments, the workpiece comprises a polymer or ceramic matrix component that is fastened to an air frame. In some embodiments, the polymer matrix is formed via a three-dimensional building process as may be known in the art, such as selective laser sintering.

The fastener assembly may be fabricated for steel, or another metal or metal alloy. In some cases, the coefficients of thermal expansion for the steel bolt assembly and the polymer matrix workpiece may differ by more than two orders of magnitude. As a result of the difference, the expansion and contraction of the bolt assembly when subject to large temperature deltas is typically much larger than that the workpiece. In some cases, such as in harsh environments subject to large temperature deltas, the contraction of the fastener assembly generates a significant compression stress on the workpiece. This stress can lead to failure, especially in stiffer work pieces such as the matrices described here. Conversely, a large expansion of the fastener resulting from an increasing temperature can cause the system through loss of compression force on the work piece. The present invention seeks to address both of the problems.

In further regard to the workpiece, the dimensional tolerance thereof may be greater than the material used for the fastener. This may occur in the context of the polymer or ceramic matrix regardless of the method of fabrication. This results in mix geometries that inhibit use of a systematic approach for tension fasteners in a larger system. Often times in a system with a plurality of fasteners, some will be too tight potentially causing damage or failure to the workpiece and other will be too loose, resulting in insufficient compressive force and also causing potential damage or failure to the workpiece.

In reference to FIG. 1, a fastener assembly 300 in accordance with the present invention is shown. The assembly 300 includes a bolt 312 extending along an axis between a proximal end and a distal end. The bolt 312 includes a head 314 at the proximal end and a threaded portion 316 at the distal portion. The head 314 is shown as a hexagonal head, but the present invention is not limited in that regard and other forms of bolts and bolt heads may be used.

The workpiece 376 defines a bore extending there through. The bore has a first opening in a first surface of the workpiece. A limiter 370 is disposed in the bore of the workpiece 376. The limiter 370 extends between a proximal end and a distal end. The limiter defines a bore between an an opening at the proximal end and an opening at the distal end. The bore is configured to receive the shaft of the bolt 312. The inside dimension of the first opening of the limiter is less than the outside diameter of the head 314. In this manner, the limiter inhibits the head 314 from passing through the bore of the limiter. In the embodiment disclose in FIG. 1, the limiter 370 is formed a material having a similar property to the bolt. In some embodiments, the bolt and the limiter are formed from the same material. For example, a steel or metal alloy.

In the embodiment shown in FIG. 1, the assembly 300 includes a blind nut 380 disposed in the bore in the workpiece. The bore passes entirely through the workpiece, however, the present invention is not limited in this regard, for example may be fixed in a blind hole formed in the work piece. The nut 380 includes threads figured to mate with the threaded portion 316 of the bolt. In this manner, the bolt 312 is coupled to the nut 380 and the assembly may be tensioned by rotating the nut relative to the bolt in a first direction. The system may be dimensioned by rotation the nut relative to the bolt in a second direction opposite the first direction.

The assembly 300 includes a first washer 322 disposed about the fastener 312 between the head of the fastener 314 and the first spring element 330. the first washer 322 is configured to transfer force between the first spring element 330 and the head of the fastener 314 when the assembly is tensioned.

A first spring element 330 is disposed about the fastener and is between the first washer 344 and the second washer 324. The first spring element 300 is configured to generate a deflection force when the first spring element is subjected to a compression force during a tensioning of the assembly. The spring element has a spring equilibrium length and a spring constant. In one embodiment of the present invention, the spring element is a compression spring that is designed to operate with a compression load so that the spring gets shorter as the tensioning load of the bolt is applied thereto. The spring element may have a spring constant of designed range of deflection of the spring. In some embodiments, the spring is variable. In certain embodiments of the present invention, the spring element comprises a wave spring. The wave spring may comprise a single turn wave spring, a multi-turn wave spring, or a nested wave spring having a plurality of turns. The spring constant may be substantially linear. Use of the term substantially indicates, as is known to persons of skill in the art, that there may be variations in the constant across the deflection cycle.

In the embodiment disclose in FIG. 1, the first washer 322, first spring 330, and second washer 324 each define an opening have a dimension that is greater than the largest outside dimension of the limiter, but less than the outside diameter of the head 314. In this manner, the first washer 322, the spring element, and the second washer 324 can be received about the limiter. This configuration enables the assembly to transfer a compression force through the work piece through the first washer 322, through the spring element 330, and through the second washer 324 to the first surface of the workpiece. The inventor has discovered that selecting a spring element 330 with an appropriate spring consent and deflection range, the disclosed fastener assembly can provide a substantially constant compression force on the work piece in spite of changes in temperature, variations in workpiece geometry, and tensioning to greater than a specified torque. For example, as increasing temperature causes the fastener assembly to expand relative to the workpiece, the spring element expands and transfers a substantially uniform compressive force over its range of deflection.

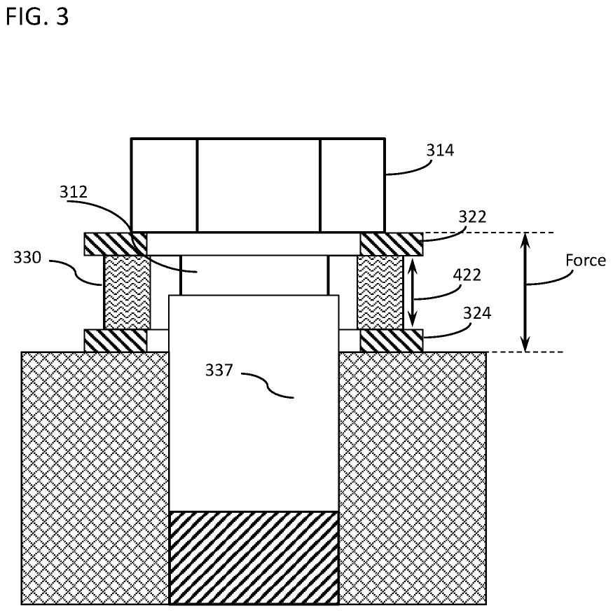

In reference to FIG. 3, a partial cross-sectional view of the fastener assembly 300 of FIG. 1 is shown. In FIG. 3, the assembly has been tensioned to a specified torque. The fastener is in tension and the bolt head 314 pulls down via a Force on the washers 322, 324, and the spring element 330. This force is transfer to the first surface of the workpiece. The spring element 330 receives the force and compresses to a length that is less than an equilibrium length of the first spring. In this manner, the spring can expand and the spring can contract in response to variable forces results from the expansion or contraction of the mismatched materials. In this manner, it is possible to increase the robustness of polymer and ceramic systems while inhibiting failure. It should be noted that while the force across the spring element 330 may vary during an acceptable range over these conditions that extension and compression of the spring ensures that an appropriate compression force is maintained on this system.

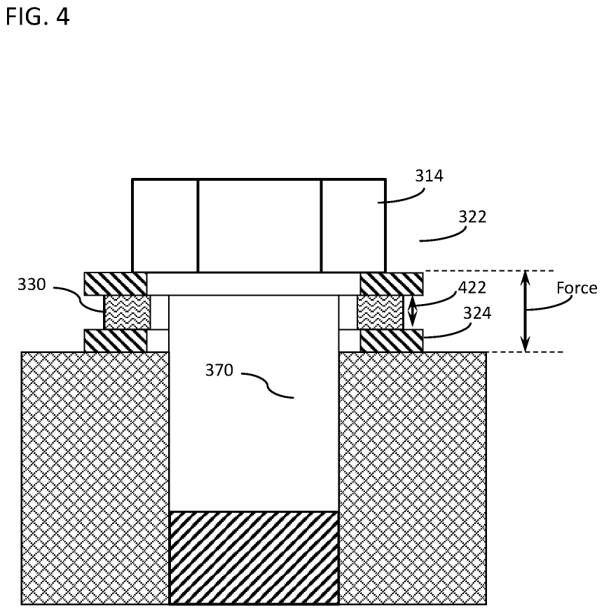

In reference to FIG. 4, a partial cross-sectional view of the assembly in FIG. 1 is shown. The fastener assembly is subjected to significant tension to the extent that it compresses the bolt head to contact the limiter. In this manner, the limiter services in inhibit over compression forces from over tensioning and bolt compression. In some embodiments of the present invention, a height of the limiter and spring element are selected to that the during installation, the fastener is tensioned until the head abuts limiter. This position is easy to identify by the operator and ensures that the workpiece will not be damaged. This configuration allows for the expansion and contract of the bolt without damaging the workpiece. It should be understood that the present invention is not limited in this regard and that other configurations are possible. For example, as disclosed herein, the fastener assembly may be tensioned so that spring element can both contract and expand before the bolt head contacts the limiter. In yet other embodiments of the present invention, the limiter is flush with the surface of the workpiece.

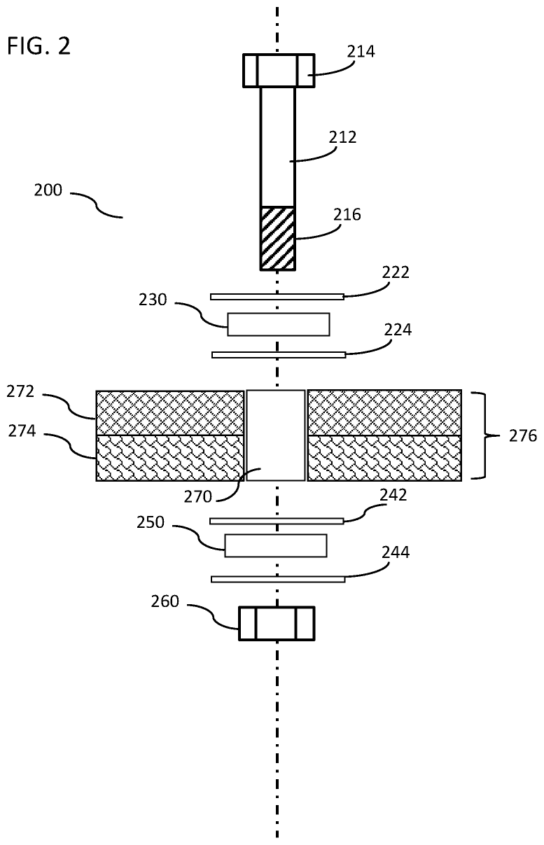

In reference to FIG. 2, a second embodiment of the fastener assembly is shown. The assembly 200 includes a workpiece 276 having first and second members 272, 274. The workpiece has a bore with a limiter disposed therein. The assembly has a 212 with a head 214 and a threaded portion 216. The assembly further includes a nut. The assembly has a first spring element 230 on a first side of the work piece and a second spring element on a second side 250 of the work piece. Both side of the system includes washes on opposing sides of the spring elements. In this manner, a through-hole bolt can be used with the workpiece and ensure that there is not failure to the workpiece resulting from thermal changes, geometric

The present disclosure describes aspects of the invention with reference to the exemplary embodiments illustrated in the drawings; however, aspects of the invention are not limited to the exemplary embodiments illustrated in the drawings. It will be apparent to those of ordinary skill in the art that aspects of the invention include many more embodiments. Accordingly, aspects of the invention are not to be restricted in light of the exemplary embodiments illustrated in the drawings. It will also be apparent to those of ordinary skill in the art that variations and modifications can be made without departing from the true scope of the present disclosure. For example, in some instances, one or more features disclosed in connection with one embodiment can be used alone or in combination with one or more features of one or more other embodiments.

What is claimed is:

1. An assembly for securing a workpiece, the assembly comprising:
a workpiece defining a bore having a first opening in a first surface of the workpiece;
a limiter extending between a proximal end and distal end, the limiter defining a bore between an opening at the proximal end and an opening at the distal end, the limiter being received in at least a portion of the bore of the workpiece;
a fastener extending along an axis between a proximal end and a distal end, the fastener having a head at the proximal end, the fastener having a plurality of threads at the distal end, the fastener being received in the bore of the workpiece so that the distal end of the fastener having the plurality of threads is opposite the first opening of the bore, the fastener further being at received in the bore of the limiter;
a first spring element disposed about the fastener and being between the head of the fastener and the first surface of the workpiece, the first spring element configured to generate a deflection force when the first spring element is subjected to a compression force during a tensioning of the assembly.

2. The assembly of claim 1, further comprising:
a first washer disposed about the fastener between the head of the fastener and the first spring element, the first washer being configured to transfer force between the first spring element and the head of the fastener when the assembly is tensioned.

3. The assembly of claim 2, further comprising:
a second washer disposed about the fastener between the first spring element and the first surface of the workpiece, the first washer being configured to transfer force between the first spring element and the first surface of the workpiece when the assembly is tensioned.

4. The assembly of claim 3, further comprising a nut received about the threaded portion of the fastener, the nut having a threaded portion configured to engage with the threaded portion of the fastener, the engagement configured whereas rotation of the fastener relative to the nut in a first direction tensions the assembly.

5. The assembly of claim 4, wherein a length of the first spring element is less than an equilibrium length of the first spring element when the assembly is tensioned.

6. The assembly of claim 5, wherein the proximal end of the limiter is one or more of flush with the first surface of the workpiece or protruding from the first surface of the workpiece.

7. The assembly of claim 6, wherein the proximal end of the limiter protrudes from the first opening in the first surface of the workpiece and is configured to inhibit a compression force generated on the workpiece caused by one or more of over tensioning of the assembly and thermal contraction.

8. The assembly of claim 7, wherein the length of the spring element varies force of the first surface of the workpiece over a working temperature delta greater than 40 degrees Celsius.

9. The assembly of claim 8, wherein the workpiece comprises one or more of a polymer matrix and a ceramic matrix.

10. The assembly of claim 9, wherein the nut comprises a blind nut disposed in bore of the workpiece.

11. The assembly of claim 5, wherein the bore in the workpiece has a second opening in a second surface of the workpiece, the threaded portion of the fastener extending through the second opening in the second surface of the workpiece, the nut being disposed about the threaded portion of the fastener.

12. The assembly of claim 11, further comprising a:
a second spring element disposed about the fastener and being between the second surface of the workpiece and the nut, the second spring element configured to generate an axial force when the second spring element is subjected to a compression force during a tensioning of the assembly.

13. The assembly of claim 11, further comprising:
a third washer disposed about the fastener between the second surface of the workpiece and the second spring element, the third washer being configured to transfer a force between the second surface of the workpiece and the second spring element when the assembly is tensioned;
a fourth washer disposed about the fastener between the second spring element and the nut, the fourth washer being configured to transfer a force between the second spring element and the nut when the assembly is tensioned.

14. The assembly of claim 13, wherein a length of the second spring element is less than an equilibrium length of the second spring element when the assembly is tensioned.

15. The assembly of claim 14, wherein the proximal end of the limiter is one or more of flush with the first surface of the workpiece and protruding from the first surface of the workpiece,
and wherein the distal end of the limiter is one or more of flush with the second surface of the workpiece and protruding from the second surface of the workpiece.

16. The assembly of claim 15, wherein the length of the first spring and a length of the second spring varies in response to temperature changes thereby a compression force on the workpiece above a threshold despite dissimilar coefficients of thermal expansion the workpiece and the fastener.

17. The assembly of claim 16, wherein the proximal end of the limiter protrudes from the first bore in the workpiece and the distal end of the limiter protrudes from the second bore and the workpiece.

18. The assembly of claim 17, wherein the length of the limiter is selected to inhibit a compression force generated on the workpiece caused by one or more of over tensioning of the assembly and thermal contraction.

19. The assembly of claim 17, wherein the length of the limiter is selected so as to define a stop point at which the assembly is properly tensioned when the proximal end of the limiter abuts the head of the fastener and the distal end of the limiter abuts the nut.

20. A method for securing a workpiece with a fastener assembly, the methods comprising the steps of:
providing a workpiece defining a bore having a first opening in a first surface of the workpiece;
providing a limiter extending between a proximal end and distal end, the limiter defining a bore between an opening at the proximal end and an opening at the distal end;
receiving the limiter in at least a portion of the bore of the workpiece;
providing a fastener extending along an axis between a proximal end and a distal end, the fastener having a head at the proximal end, the fastener having a plurality of threads at the distal end;
receiving the fastener in the bore of the workpiece so that the distal end of the fastener having the plurality of threads is opposite the first opening of the bore;
receiving the fastener in the bore of the limiter;
providing a first spring element disposed about the fastener and being between the head of the fastener and the first surface of the workpiece;
tensioning the fastener so that the first spring element generates a deflection force when the first spring element is subjected to a compression force caused by the tensioning.

21. An assembly for securing a workpiece defining a bore having a first opening in a first surface of the workpiece, the assembly comprising:
a limiter extending between a proximal end and distal end, the limiter defining a bore between an opening at the proximal end and an opening at the distal end, the limiter being received in at least a portion of the bore of the workpiece;
a fastener extending along an axis between a proximal end and a distal end, the fastener having a head at the proximal end, the fastener having a plurality of threads at the distal end, the fastener being received in the bore of the workpiece so that the distal end of the fastener having the plurality of threads is opposite the first opening of the bore, the fastener further being at received in the bore of the limiter;
a first spring element disposed about the fastener and being between the head of the fastener and the first surface of the workpiece, the first spring element configured to generate a deflection force when the first spring element is subjected to a compression force during a tensioning of the assembly.
